(19) United States
(12) Patent Application Publication
(10) Pub. No.: US 2005/0149336 A1
(43) Pub. Date: Jul. 7, 2005

(54) Voice to image printing

(76) Inventor: Matthew B. Cooley, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/747,422

(22) Filed: Dec. 29, 2003

(51) Int. Cl. G10L 11/00

(52) U.S. Cl. 704/277

(57) ABSTRACT

Methods, devices, and systems for voice to image printing are provided. One method includes translating voice input into text on a printing device. The method also includes associating the text with an image. The method further includes editing the text on the printing device. In addition, the method includes printing the image with associated text.

Digital image processing allows images to be captured in digital format. Captured images can then be stored and archived in electronic file formats within an imaging device or system such as a PC, a network system, or other memory storage device.

Captured images can also be reproduced as hard copies through utilization of a printing device. Digital technology also allows images to be edited, formatted, and grouped before an image is printed, thereby allowing added flexibility in image processing.

In some instances a program can be used to type captions, and text annotations, for association with digital images through a personal computer interface. However, the use of the computer presents an added step to the photo process that some users will choose not to employ. Another issue encountered in attaching information to images is in remembering the events, times, and places surrounding the capturing of the image. For example, many images may be captured digitally over a period of time and then some time later downloaded for printing. Additionally, physically annotating and/or using a program to edit a large group of collected images can be time consuming.

Recording information associated with images can aid in presenting and storing the images. For example, attaching information identifying the date and/or location, e.g., to capture when or where the image was taken, can aid in understanding the context of an image or in classifying the image for purposes of storage, among other things. Sometimes, individuals will hand-write such information on their processed photos. Text can also be added to personalize or add creativity to photos.

### BRIEF DESCRIPTION OF THE DRAWINGS

FIG. 1 illustrates an embodiment of a printing device.

FIG. 2A illustrates a block diagram of an embodiment of translation and/or association components.

FIG. 2B illustrates a block diagram of an embodiment of electronic components for a device.

FIG. 3 illustrates a method embodiment.

FIG. 4 illustrates another method embodiment.

FIG. 5 illustrates another method embodiment.

FIG. 6 illustrates a system embodiment.

### DETAILED DESCRIPTION

Embodiments of the invention provide various techniques for captioning, or otherwise annotating image files, and include systems and devices for performing the same. As used herein, the terms captions and annotations can be used to refer to dates, times, places, people, events, titles, and/or other types of information. Various embodiments provide the ability to add captions and/or annotations to image files using voice input. The voice input is translated to text which can then be associated with one or more selected image files. Voice input associated with an image can be previewed and edited prior to translating the voice input to text and/or prior to printing. The previewing and/or editing of the voice and/or image data can be performed on a printing device. In editing, the captions and/or annotations can be selectably located for printing on the image, such as selected locations on the back or front of the print media to which the image is printed.

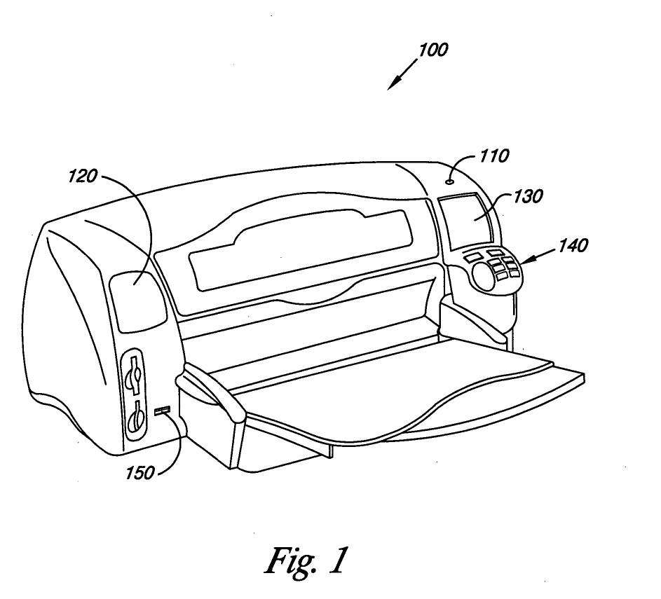

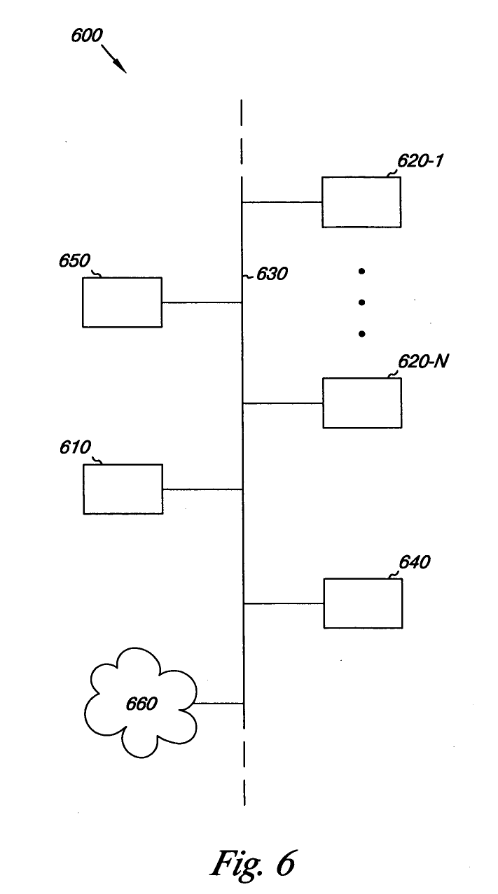

FIG. 1 provides a perspective illustration of an embodiment of a printing device 100 which is operable to implement embodiments of the invention. The embodiment of FIG. 1 illustrates an inkjet printing device 100, as can be used in an office or home environment. Embodiments of the invention, however, are not limited to use with inkjet printers. A printing device, such as that shown in FIG. 1, can be used as a stand alone device and/or can be connected to network or system as shown in FIG. 6.

As shown in the embodiment of FIG. 1, the printing device 100 can include a microphone 110 to receive voice data. The printing device also can include a speaker to preview, e.g., playback, received voice data 120. The printing device 100 can include a display 130 to preview image data, a keypad 140 for data entry, and an input/output (I/O) port 150 for receiving data from other media. The I/O port 150 can include a slot for a flash card or other type of computer readable media and/or can include a port such as a Universal Serial Bus (USB) port operable to download data, however the embodiments of the invention are not so limited.

According to embodiments, image data can be received by the printing device 100 using the I/O port 150. The image data can be previewed as a collective group of image thumbnails and/or image by image on the display 130. Keys on the keypad 140 can be used to select how the images are presented and to select which image or images are displayed. While either an individual image or group of images is being displayed, voice data can be input to the printing device 100 using the microphone 110. Software (e.g., computer executable instructions) can associate the recorded voice data with the image or group of images being displayed. For example, the voice data can be stored in memory as an audio or voice file which can be linked to a particular image or group of images also stored in memory. Association of voice data can be accomplished, for example, by using computer executable instructions stored in memory that can be executed by a processor to provide an encoded marker which identifies one or more voice data files to be accessed with one or more image data files.

The speaker 120 can be used to play back the recorded voice data and by using the microphone 110, speaker 120, display 130, and/or input keys 140, the recorded voice data can be re-recorded or edited to add or delete portions, or all, of the recorded voice data. Additionally, computer executable instructions can translate naturally spoken voice data into text data. Computer executable instructions can also allow the use of naturally spoken voice input to edit and format translated text data. Those skilled in the art will understand that various computer executable instructions can accomplish naturally spoken voice to text translation and/or editing. The computer executable instructions can be written in various programming languages. For example, the instructions can be written in JAVA or C++ programming languages, among others.

Once the voice data has been translated to text, the text can be presented with the image on the display 130. According to various embodiments, program instructions (e.g., computer executable instructions) are provided to the printing device 100 which can execute to edit and/or locate the text presented with the image on the display 130 prior to printing. One of ordinary skill in the art will appreciate the various input devices, e.g., including the keys on the keypad 140, a keyboard, mouse, touch screen, etc. which can be used to interact with the program instructions on the printing device 100. The instructions can be stored in memory on the printing device 100 and executed by a processor thereon. In this manner, the text can be edited and located in association with select images. The program instructions can execute to collectively associate a group of selected images with a single annotation. This can be performed whether the images are presented as thumbnails on an index sheet or individually marked or selected when presented on the display 130. For example, a user can provide input to the printing device 100 to select a collection of images presented on the display 130 and to label all of the selected images as “Christmas 2003”. Again, the instructions are not limited to any particular programming language.

The program instructions can execute to record audio using the microphone 110, playback the audio for a user's review using the speaker 120, and/or re-record audio to associate with a particular image or group of images and re-translate to text in association with a particular image and/or group of images. For example, an audio file translated to text in association with one or a group of images may produce a caption that labels certain images as “Christmas 1999.” Upon review of the text presented with the image on the display, a user may realize that these images are actually from “Christmas 2000” and may thus edit the translated text associated with the one or more images directly on the printing device 100. The user may also elect in editing where they would like the caption to appear in association with a printed image. For example, the program instructions can execute on the printing device 100 in response user input selecting to print the caption at a bottom, a top, a side margin, and/or a back of the printed image. Embodiments, however, are not limited to these examples.

Further, the program instructions can execute to generate and save a first version of the text annotation linked with one or more particular images to a file in memory on the printing device 100. In this manner, a user can later retrieve the file including the first version text annotations associated with various images to re-edit the text to generate a second version of the text annotations. Again, a user can provide input via the microphone 110 to record a new audio (i.e., the second version of the text annotations) in association with an image presented on the display 130, playback the audio file for review using the speaker 120, and re-record, etc. to translate in association with the image, and/or the user can use the keypad 140 to create new text to associate with the images for a different audience. These new text annotations (e.g., the first version and the second version of the text) can similarly be saved to a file, e.g., a different file version such as a first memory file and a second memory file, in memory on the printing device 100. In this manner, a user may chose to label certain images as “Honeymoon” for a family member audience and save those to images with their associated caption to one file and the user can then, or at a later time, select to label the same images with different captions, e.g., “Trip to Rio” to an additional file for sharing with other colleagues and acquaintances.

As one or ordinary skill in the art will appreciate upon reading this disclosure, the program instructions provided to the printing device 100 can execute to facilitate a wide variety of initial editing to add captions to particular images presented in association with images on the display. And, program instructions can execute to facilitate subsequent editing and revision of audio files which have been previously translated to text in association with various images by the translation program instructions described above. Again, the keys on the keypad 140 can be used to adjust the qualities of the text and/or the location of the text on the image prior to printing or to edit the text further, such as by selecting the text font, color, and size of the image. In addition, the text can be selectably positioned at the bottom, top, side, and/or back of the image. However, embodiments of the present invention are not so limited.

According to embodiments, image data can be received by the printing device 100, as described above, with the image data already having voice data associated therewith. In these embodiments, software on the printing device can translate the associated voice data to text and present the text with the image on the display 130, as has been described above. Additionally, the microphone 110, speaker 120, display 130, and/or input keys 140 can be used to further edit the associated voice data or text to annotate one or more images or groups of images in the manner described above.

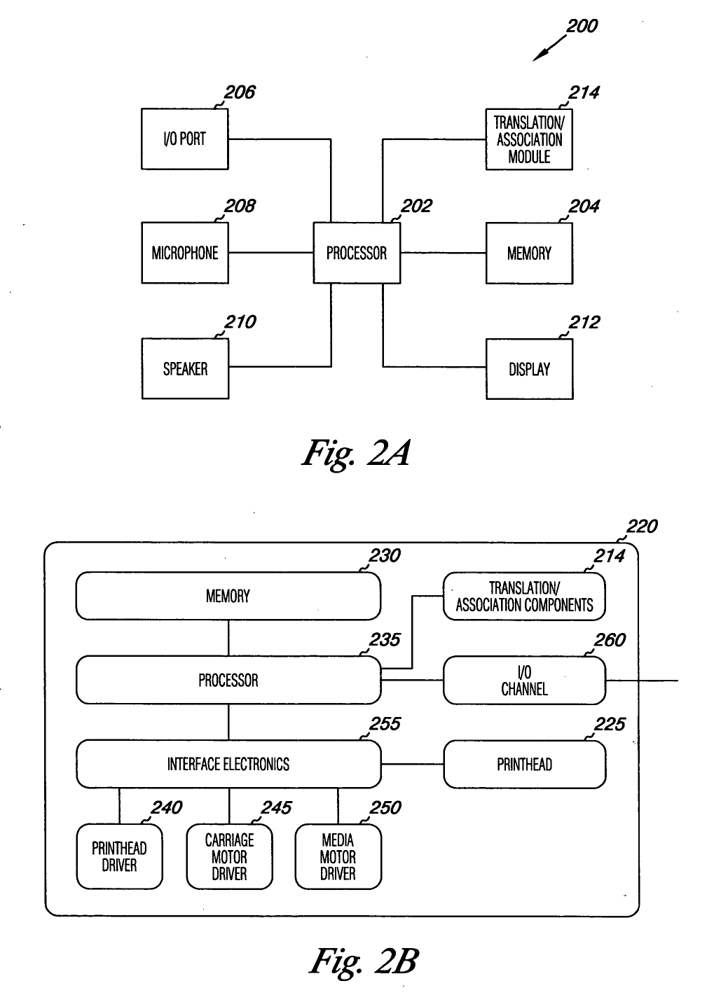

FIG. 2A illustrates a block diagram embodiment of electronic components 200 in a device capable of voice to image captioning. In the embodiment shown in FIG. 2A, these components 200 include a processor 202, memory 204, I/O port 206, microphone 208, speaker 210, display 212, and translation/association module 214. Examples of memory types include Non-Volatile (NV) memory (e.g. Flash memory), RAM, ROM, magnetic media, and optically read media and includes such physical formats as memory cards, memory sticks, memory keys, CDs, DVDs, hard disks, and floppy disks, to name a few. The embodiments of the invention, however, are not limited to any particular type of memory medium and are not limited to where within a device or networked system a set of computer instructions reside for use in implementing the various embodiments of invention. One of ordinary skill in the art will appreciate the manner in which an I/O port 206, microphone 208, speaker 210, display 212, and translation/association module 214 can be interfaced with the processor 202 and memory 204. Embodiments of the invention can be used with various microphone, speaker, and display types and can be include touch screens that can be used to enter text or select images and/or edit images.

The processor 202 and/or components such as memory 208, I/O port 206, microphone 208, speaker 210, display 212, and translation/association module 214 can receive data and executable instructions to process the data according to embodiments described herein. The processor 202 can be interfaced with the translation/association module 214 and can execute software instructions to carry out various control steps and functions for a printing device as well as perform embodiments of the invention. One of ordinary skill in the art will appreciate the manner in which software, e.g. computer readable instructions, can be stored on a memory medium.

The translation/association module 214 includes software to perform voice to text translation and association of translated text to image files. One of ordinary skill in the art will appreciate that the translation/association module 214 can be a combined module as illustrated in the embodiment of FIG. 2A, or can include separate modules, e.g. one module that includes software to perform voice to text translation and another module that includes software to perform an association of the voice to text translation with image files. Embodiments of the invention are not so limited.

For the purpose of the present disclosure, images include digital image files such as digital photographs and the like. Image files operated on by various embodiments of the present invention can be captured through devices such as digital cameras, scanners, or other devices capable of either direct digital image capture or devices such as those that provide conversion of an analog image to a digital format. Various types of image formats can be utilized with the embodiments of the invention. For example, image files can be received in GIF, JPEG, BMP, and TIFF file formats.

In addition, for the purpose of the present disclosure, voice input can include various auditory input types, including speech. In various embodiments, voice input can be captured directly and/or captured through a separate device, e.g., a digital camera. Voice input can be received through a microphone, e.g., microphone 110 in FIG. 1 and/or 208 in FIG. 2A. Voice input can also be received as an audio file. The voice input can be stored in memory as voice data. Voice data can be stored in various formats, including but not limited to MP3 and WAV file formats as the same are known.

Embodiments of the present invention using the translation/association components 200 in a device, such as a printing device, can allow direct voice to text printing. This feature can allow for dictation of voice input and translation of the voice input to text data for printing. However, the translation can occur at various times. For example, the voice data can be translated when received or can be translated at a later time.

FIG. 2B illustrates an embodiment of the electronic components associated with a printing device 220, such as printing device 100 in FIG. 1. As shown in FIG. 2B, the printing device 220 can include a media marking mechanism such as printhead 225. The electronic components include a memory 230 and a processor 235 which can serve as a controller. Executable instructions can be stored in memory 230 and can be executed by the processor 235. FIG. 2B illustrates printhead driver 240, a carriage motor driver 245, and a media motor driver 250. As shown in the embodiment of FIG. 2B, interface electronics 255 can connect the processor 235 and other components of the printing device 220. For example, printhead driver 240, a carriage motor driver 245, and a media motor driver 250 are coupled to interface electronics 255 for moving the printhead 225, print media, and for firing individual nozzles on the printhead 225. The printhead driver 608, the carriage motor driver 610, and the media motor driver 612 can be independent components or combined on one or more application specific integrated circuits (ASICs). The embodiments, however, are not so limited. Computer executable instructions, or routines, can be executed by these components. As shown in the embodiment of FIG. 2B, the interface electronics 255 interface between control logic components and the electromechanical components of the printer such as the printhead 225.

The processor 235 is also coupled to a translation/association module 214 as the same has been described in connection with FIG. 2A. Software embodiments of the present invention are executable by the translation/association module 214 and processor 235 to translate voice data to text for printing with associated image files as well as to edit the location of the text on printed images. The translation/association module 214 can also associate and save in memory the text data, including associated versions of text data with the image. However, embodiments of the present invention are not so limited.

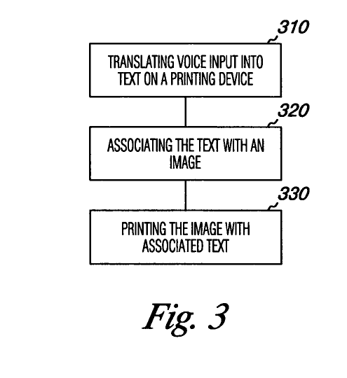

FIGS. 3-5 illustrate various method embodiments which provide for voice to image captioning. The methods described herein can be performed by software (e.g. computer executable instructions) operable on the systems and devices shown herein or otherwise. The embodiments of the invention, however, are not limited to any particular operating environment or to software written in a particular programming language. Unless explicitly stated, the methods described below are not constrained to a particular order or sequence. Additionally, some of the methods can be performed at the same point in time. Software, to perform various method embodiments can be located on a computer readable medium.

FIG. 3 illustrates a method embodiment for voice to image captioning. The method includes translating voice input into text on a printing device, as shown at block 310. Software is provided to the printing device such as to the translation/association module 214 described above in connection with FIGS. 2A and 2B. The software is executable to receive voice input from one or more sources, e.g., as input from a microphone such as 110 in FIG. 1 and/or 208 in FIG. 2A, and/or from an I/O port such as data port 150 in FIG. 1 and/or I/O port 206 in FIG. 2A. The software executes on the printing device to translate the voice data to text data. One of ordinary skill in the art will appreciate the manner in which voice to text software can translate voice data to text. In one embodiment, translating naturally spoken voice input into text data can include receiving the naturally spoken voice input using a microphone on the printing device and storing the translated voice to text data in memory on the printing device. The stored text data can later be retrieved and operated on by software embodiments in connection with the processor, e.g., processor 202 in FIG. 2A or 235 in FIG. 2B. Voice data, such as audio files in WAV or MP3 format, can also be transferred to the printing device and then translated into text which can be stored in memory.

The method also includes associating the translated text with an image as shown in block 320. For example, software provided to a printing device can execute to receive image data from one or more sources, e.g., as input from a flash memory card or over a universal serial bus (USB) connection to an I/O port on the printing device such as data port 150 in FIG. 1 and the I/O port 206 in FIG. 2A, and can execute to associate the translated text with the image data. One of ordinary skill in the art will appreciate the manner in which software can execute to receive image data on a printing device. Received image data can be stored in memory on the printing device and can be selectively retrieved and operated on by software embodiments in connection with the processor, e.g., processor 202 in FIG. 2A or 235 in FIG. 2B.

The received image data can be displayed to a user of the printing device such as on display 130 of FIG. 1 and/or display 212 in FIG. 2A. In various embodiments, a user can preview image data received on the printing device as thumbnail images on a display screen on the printing device. Software embodiments can similarly retrieve stored text data files resulting from translation in block 310 and provide the translated voice to text data to the display screen for viewing by a user. The software embodiments allow a user to select various text data files, e.g., using keys on keypad 140 shown in FIG. 1, to link text data with one or more image files. For example, a user can mark a particular image or group of images to be associated with certain text data. So marked, the software can execute to store the association between a given image or group of images with that particular text.

Association can also include retrieving image data from memory on the printing device and printing an image proof sheet showing various images. The various images can be identified by a number or letter designation. Text data files can also be retrieved from memory on the printing device and printed for review. In various embodiments, the user can mark particular text files to associate them with particular images. In these embodiments marked proof sheets and text sheets can be scanned back into the printing device. The software receives the scanned data from the proof sheet and the text sheet to associate particular image data with particular text data. Thus, various software embodiments are provided which can associate translated text with an image.

Voice input and/or text data, as described above, can serve as captions or annotations to the image data and can cover various types and subject matter. For example, voice input and/or text captions can include, but are not limited to, events, dates, subjects, participants, and/or locations. In addition, embodiments of the invention can be designed such that multiple captions can be associated with an image. For example, the image can be associated with a text description of the image, such as “Matt's Birthday” and can also be associated with the date “April 2003” or a location, such as “Lake Michigan”. In addition, multiple image files can be associated with a particular text caption file.

The method of FIG. 3 also includes printing an image with associated text at block 330. However, according to embodiments, the software can allow for different translated text captions to be reviewed, edited, and located as to where the translated text captions will appear relative to the image once printed to print media. For example, the software embodiments will allow a user to preview one or more images with associated text captions on a display screen prior to printing. The preview can allow the user to edit the associated text prior to printing, such as by modifying, deleting, formatting, and/or adding new text. Editing can include use of an input device such as a keypad, touch screen and/or a microphone, as described above. Text formatting can include changing text size, color, font, and text placement on the print media in association with one or more images, such as on the front or back of the media. For example, the software can be used to select that the text description be printed on the front of the printed media with the image, while the date and/or location can be printed on the back of the printed media.

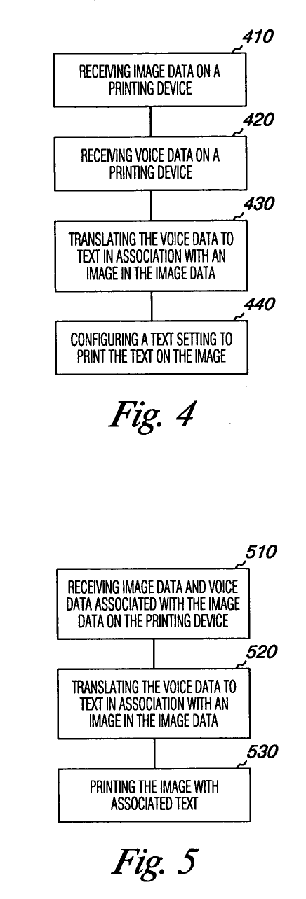

FIG. 4 illustrates another method embodiment for voice to image captioning. In the embodiment shown in FIG. 4, the method includes receiving image data on a printing device at block 410. Image data can be received as the same has been described herein. For example, image data can be captured using a device such as a digital camera and then transferred to the printing device via a USB connection or flash memory card. Likewise, the image data can be captured using a scanning device and then transferred to the printing device over a network such as the network described in FIG. 6. Image data can be transferred over a network to the printing device using wired and/or wireless connections, e.g., infrared (IR) signals and RF signals. Receiving image data can include receiving an image file in a file format selected from the group including JPEG, BMP, and TIFF, among others.

As shown in FIG. 4, the method also includes receiving voice data on a printing device at block 420. Voice data can be from a microphone such as 110 in FIG. 1 and/or 208 in FIG. 2A, and/or from an I/O port such as data port 150 in FIG. 1 and/or I/O port 206 in FIG. 2A. Receiving voice data can include receiving voice data transferred from a remote device in file formats such as WAV or MP3, among others.

In various embodiments, the user may preview image files using a display screen and record naturally spoken voice input through a microphone for association with images files, for example, while the images are being previewed. Receiving voice data can include first recording naturally spoken voice input and storing the voice files in memory for later association with image files.

In various embodiments, the method can also include editing the voice file on a printing device. For example, the user may preview the voice file through a speaker and elect to re-record or edit the entire naturally spoken voice file or portions of the naturally spoken voice file through microphone, keypad, and/or touch screen input. In such embodiments, the voice files can be the voice recording of the user entering the voice input or can be a text to voice program reading back the text.

In the embodiment of FIG. 4, the method also includes translating the voice data to text in association with an image at block 430. Software is provided to the printing device, such as to the translation/association module 214 described above in connection with FIGS. 2A and 2B, to translate received voice or audio file input. The software executes on the printing device to translate the voice or audio file input to text data. Translating voice input into text data can include receiving the naturally spoken voice input using a microphone on the printing device and storing the translated voice to text data in memory on the printing device. The stored text data can later be retrieved and operated on by software embodiments in connection with the processor, e.g., processor 202 in FIG. 2A or 235 in FIG. 2B.

In various embodiments of the present invention, the user can select one or more naturally spoken voice files stored in memory and associate these files with one or more image files also stored in memory. Selection of voice and image files can be conducted through keypad or touch screen entry, or voice command through a microphone; however, embodiments of the present invention are not so limited. Once the voice and image files are selected for association, computer executable instructions stored in memory and operable on by a processor can translate the voice data to text data and associate the translated text data with the selected image files. The voice files can also be translated and the translated text can be stored in memory for later association with image files.

In various embodiments of the present invention, the user can preview the translated text caption on a display screen and edit the caption prior to printing. By way of example and not by way of limitation, caption editing can be conducted through additional voice input, such as through the use of a microphone and/or keypad or touch screen. Additional voice input can be recorded, translated, and/or associated with the image to edit the caption. The caption can also be edited through the use of a keypad, touch screen or other input device to alter text within the caption. The edited text can then be associated with one or more image files; however, embodiments of the present invention are not so limited.

The embodiment of FIG. 4 also includes configuring a text setting to print the text on the image at block 440. In various embodiments, configuring text settings can include selecting text qualities and/or a location on the image to print the text. For example, the user may select text qualities including font, color, and size. The user can specify that the text be printed at a particular location on the image and/or print media, including printing the text on the reverse side of the print media. Embodiments of the present invention are not so limited.

FIG. 5 illustrates a method embodiment in which image data having associated voice data is received by a printing device. The method of FIG. 5 includes receiving image data and voice data, associated with the image data, on a printing device as shown in block 510. As an example, receiving image data can include receiving image data and voice data (e.g., as IR signals) from a remote device (e.g., digital camera or scanner). Voice and image files can also be captured by different remote devices and associated at a host device such as a personal computer prior to transferring to a printing device or at the print device itself. For example, an image can be digitized through the use of a scanning device and stored on a personal computer as an image file. Voice data can be recorded at the personal computer or other remote devices, e.g., recorded on a digital camera, and associated with the captured image file. The image and associated voice files can then be transferred (e.g., sent or copied) to the printing device for further processing. However, the various embodiments of the present invention are not so limited.

The embodiment of FIG. 5 also includes translating the voice data to text in association with an image in the image data at block 520. Software embodiments enable the translation of voice data, and/or audio file data, as the same have been described herein. Voice data, and/or audio file data input can be edited through additional voice input prior to translation. For example, after the voice data and/or audio file data is received by the printing device, the printing device can play the voice data and/or audio file data using a speaker such as speaker 120 shown in FIG. 1. One or more images can be selectably displayed as the voice data and/or audio file is played. As previously described, editing can include additional voice input through a microphone and/or data entry through a keypad or touch screen. The edited voice and/or audio file data can then be stored and re-associated with the particular image data being viewed. Software is provided to the printing device, such as to the translation/association module 214 described above in connection with FIGS. 2A and 2B, to associate the voice and/or audio file input with user selectable images. Previously edited and/or newly received voice data and/or audio file data can be associated with images and/or groups of images. Hence, software embodiments, as described herein, allow a user to edit, add, and/or delete voice data and/or audio file data at the printing device as well as edit, add, and/or delete text data which has been translated from voice at the printing device. As shown in FIG. 5, the method includes printing the image with associated text at block 530.

FIG. 6 illustrates a system environment according to various embodiments of the invention. As shown in FIG. 6, the system 600 can include an imaging component 610, a number of remote devices 620-1 to 620-N, a number of data links 630, a printing device 640, a storage device 650, and an Internet link 660.

As shown in the embodiment of FIG. 6, the printing device 640 can be networked to one or more remote devices 620-1 to 620-N over a number of data links 630. According to the various embodiments, the printing device 640 includes a printing device capable of voice to image captioning as the same has been described herein. As one of ordinary skill in the art will appreciate upon reading this disclosure, the number of data links 630 can include one or more physical connections, one or more wireless connections, and/or any combination thereof. That is, the printing device 640 and the one or more remote devices 620-1 to 620-N can be directly connected and/or can be connected as part of a wider network through the number of data links 630.

As shown in FIG. 6, the system 600 further includes an imaging component 610. In various embodiments, including the embodiment shown in FIG. 6, the imaging component 610 can include the device such as a digital camera or scanning devices. However, embodiments of the present invention are not so limited.

It is noted that any number of remote devices and remote device types can be networked over data links 630 to the imaging component 610 and the printing device 640. That is, in various embodiments, the one or more remote devices 620-1 to 620-N can include a remote device such as a wireless phone, a personal digital assistant (PDA), or other hand-held device.

In various embodiments, the one or more remote devices 620-1 to 620-N can include remote devices such as desktop computers, laptop computers, or workstations, among other device types. In some instances, remote devices 620-1 to 620-N can include peripheral devices distributed within the network. Examples of peripheral devices include, but are not limited to, scanning devices, fax capable devices, copying devices, and the like.

As noted above, in various embodiments, a printing device 640 can include a multi-function device having several functionalities such as printing, copying, and scanning included. As will be known and understood by one of ordinary skill in the art, such remote devices 620-1 to 620-N can also include a number of processors and/or application modules suitable for running software and can include a number of memory components thereon.

As shown in the embodiment of FIG. 6, a system 600 can include one or more storage devices 650, e.g. remote storage database and the like. Likewise, the system 600 can include one or more Internet connections 660 as shown in the embodiment of FIG. 6.

As one of ordinary skill in the art will appreciate upon reading this disclosure, the network described herein can include any number of network types including, but not limited to, a Local Area Network (LAN), a Wide Area Network (WAN), a Personal Area Network (PAN), and the like. And, as stated above, data links 630 within such networks can include any combination of direct or indirect wired and/or wireless connections, including but not limited to electrical, optical, and RF connections.

Although specific embodiments have been illustrated and described herein, those of ordinary skill in the art will appreciate that any arrangement calculated to achieve the same techniques can be substituted for the specific embodiments shown. This disclosure is intended to cover any and all adaptations or variations of various embodiments of the invention.

It is to be understood that the above description has been made in an illustrative fashion, and not a restrictive one. Combination of the above embodiments, and other embodiments not specifically described herein will be apparent to those of skill in the art upon reviewing the above description. The scope of the various embodiments of the invention includes any other applications in which the above structures and methods are used. Therefore, the scope of various embodiments of the invention should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the embodiments of the invention require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

1. A method for image captioning, comprising:
translating voice input data into text data on a printing device;
associating the text data with an image;
editing of text data on the printing device; and;
printing the image with the text data.

2. The method of claim 1, wherein translating the voice input data into text data on the printing device includes using a set of naturally speaking voice to text computer executable instructions.

3. The method of claim 1, wherein translating the voice input data into text data includes translating using a set of voice to text computer executable instructions written in JAVA programming language.

4. The method of claim 1, wherein associating the text data with an image includes associating text data selected from a text data group including: an event, a date, a participant, multiple participants, and a location.

5. The method of claim 1, wherein the method further includes providing a preview of the image with the text data prior to printing.

6. The method of claim 1, wherein editing of text data on the printing device includes using a keypad on the printer device to edit text data to the image.

7. The method of claim 1, wherein editing of text data on the printing device includes re-recording voice input data on the printing device.

8. The method of claim 7, wherein the method further includes translating the re-recorded voice input data on the printing device.

9. The method of claim 1, wherein editing of text data on the printing device includes:
generating a first version of the text data for the image on the printing device; and
associating the first version of the text data with the image to a first memory file.

10. The method of claim 9, wherein the method further includes:
generating a second version of the text data for the image on the printing device; and
associating the second version of the text data with the image to a second memory file.

11. The method of claim 10, wherein the method further includes editing the first version and the second version of the text data.

12. The method of claim 1, wherein editing of text data on the printing device includes:
selecting a group of images for a first version of the text data; and
associating the first version of the text data with the group of images on a first memory file.

13. The method of claim 12, wherein editing further includes:
editing the text data on the printing device to generate a second version of the text data for the group of images; and
associating the second version of the text data with the group of images on a second memory file.

14. A method for image captioning, comprising:
receiving an image data file on a printing device;
receiving a voice data file on the printing device;
translating the voice data file to text data in association with the image data file;
editing of text data on the printing device; and
configuring a text setting to print the text data with the image data.

15. The method of claim 14, wherein configuring the text setting includes selecting a location on an image in the image data to print the text data.

16. The method of claim 14, wherein configuring the text setting includes printing the text data on the reverse side of a print media.

17. The method of claim 14, wherein receiving the voice data on the printing device includes previewing the image data and recording the voice data to the printing device in association with the image data.

18. The method of claim 17, wherein receiving the image data and receiving the voice data includes receiving multiple image data files associated with multiple voice data files.

19. The method of claim 14, translating the voice data to text data in association with the image data includes associating the voice data file with multiple image data files.

20. The method of claim 14, wherein the image data files include files in a file format selected from the group of JPEG, BMP, and TIFF.

21. The method of claim 14, wherein the voice data file includes files in a file format selected from the group of MP3 and WAV.

22. The method of claim 14, wherein editing of text data on the printing device includes using a keypad on the printer device to edit text data to the image.

23. The method of claim 14, wherein editing of text data on the printing device includes re-recording voice data file on the printing device.

24. The method of claim 23, wherein the method further includes translating the re-recorded voice data file on the printing device.

25. A computer readable medium having a set of computer executable instructions thereon for causing a printing device to perform a method, the method comprising:
receiving an image data file on the printing device;
receiving a voice data file on the printing device;
translating the voice data file to text data in association with the image data file;
editing of text data on the printing device; and
configuring a text setting to print the text data with the image data.

26. The medium of claim 25, wherein the method further includes editing the voice data file on the printing device.

27. The medium of claim 25, wherein receiving a voice data file on the printing device includes recording the voice data file on the printing device and associating the recorded voice data file with the image data file.

28. The medium of claim 25, wherein the method further includes previewing the voice data file.

29. The medium of claim 25, wherein the method further includes previewing the text data file.

30. The medium of claim 25, wherein editing of text data on the printing device includes using a keypad on the printer device to edit text data to the image.

31. A computer readable medium having a set of computer executable instructions thereon for causing a printing device to perform a method, the method comprising:
receiving image data files on the printing device;
selecting a group of image data files;
associating a single text data file with the group of image data files; and
printing the group of image data files with the single text data file.

32. The medium of claim 31, wherein receiving image data files includes receiving image data files as infrared signals from a digital camera.

33. The medium of claim 31, wherein the method further includes operating on the received image data files and the single text data file prior to printing.

34. The medium of claim 33, wherein operating on the single text data file includes editing the single text data file prior to printing.

35. A printing device, comprising:
an input/output (I/O) port for receiving voice input data;
a processor;
a memory;
a media marking mechanism;
interface electronics coupling the I/O port, processor, memory, and media marking mechanism; and
a set of computer executable instructions operable on the interface electronics to;
translate voice input data into text on a printing device;
associate the text with an image;
edit the text; and
print the image with associated text.

36. The device of claim 35, wherein the I/O port includes a universal serial bus connection.

37. The device of claim 35, wherein the media marking mechanism includes a printhead.

38. An imaging system, comprising:
a processor;
a memory;
a media marking mechanism;
interface electronics coupling the processor, the memory, and the media marking mechanism; and
means for receiving image data and voice data; and
means for translating the voice data to text data.

39. The system of claim 38, wherein the means for receiving image data and voice data includes receiving image data having voice data associated therewith.

40. The system of claim 38, wherein the means for receiving image data and voice data includes receiving image data and voice data independently.

41. The system of claim 38, wherein the means for receiving image data and voice data associated with the image data includes a set of computer executable instructions operable on an audio file format and an image file format.

42. The system of claim 38, wherein the means for receiving the image data and the voice data includes a universal serial bus connection to receive image data and voice data from a digital camera.

43. The system of claim 38, wherein means for translating the voice data to text includes a set of computer executable instructions for naturally speaking voice to text translation.
